(19) United States
(12) Patent Application Publication
(10) Pub. No.: US 2008/0201398 A1
(43) Pub. Date: Aug. 21, 2008

(54) Determination of a Modular Inverse

(76) Inventor: Bernd Meyer, Munchen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/915,081

(22) PCT Filed: May 19, 2006
(86) PCT No.: PCT/EP2006/062443

§ 371 Date: Nov. 20, 2007

(30) Foreign Application Priority Data
May 25, 2005 (DE) 10 2005 024 609.5

(51) Int. Cl. G06F 7/72

(52) U.S. Cl. 708/491

(57) ABSTRACT

In side-channel attack-resistant encoding methods, a return value (r) is determined as the modular inverse of an input value (a), by a module (M). A resistance to side-channel attack can be achieved with minimal restrictions on implementation on determination of the modular inverse with minimal technical complexity. To this end, in a first sub-step, a first product (d) of the input value (a) and a random number is generated (c), in a second sub-step, the modular inverse (e) of the first product (d) is determined by the module (M), in a third sub-step, a second product (b) of the random number (c) is determined by the modular inverse (e) and in a fourth sub-step the return value (r) is set to the same as the second product (b).

### CROSS-REFERENCE TO RELATED APPLICATIONS

This application is a U.S. national stage application of International Application No. PCT/EP2006/062443 filed May 19, 2006, which designates the United States of America, and claims priority to German application number 10 2005 024 609.5 filed May 25, 2005, the contents of which are hereby incorporated by reference in their entirety.

### TECHNICAL FIELD

The invention relates to a method for side-channel-attack-resistant computation of a return value as a modular inverse of an input value using a module.

### BACKGROUND

Side channel attacks are a class of methods for cryptanalysis. In contrast to previous attacks on cryptographic applications, an attacker in this case does not attempt to break the underlying abstract mathematical algorithm but rather attacks a specific implementation of a cryptographic method. To this end, the attacker uses easily accessible physical measured variables for the actual implementation, such as computation runtime, power consumption and electromagnetic radiation from the processor during computation or the implementation's behavior when errors are induced. The physical measured values from a single computation can be analyzed directly, for example using simple power analysis [SPA], or an attacker records the measured values from a plurality of computations (for example using a storage oscilloscope) and then evaluates the measured values statistically, for example using differential power analysis [DPA]. Side channel attacks are frequently much more efficient than conventional cryptanalysis techniques and can even break methods which are considered to be secure from the point of view of the algorithms if the implementation of these algorithms is not protected against side channel attacks. Countermeasures to prevent side channel attacks are particularly important for smart cards and embedded applications.

Side channel attacks are already dealt with in the following publications: Kocher: Timing attacks on implementations of Diffie-Hellman, RSA, DSS, and other systems, Crypto 1996, LNCS 1109, pages 104-113, Springer; Kocher, Jaffe, Jun: Differential power analysis, Crypto 1999, LNCS 1666, pages 388-397, Springer; Messerges, Dabbish, Sloan: Power analysis attacks of modular exponentiation in smartcards, CHES 1999, LNCS 1717, pages 144-157, Springer.

In this context, Boneh, Demillo, Lipton: On the importance of checking cryptographic protocols for faults, Eurocrypt 1997, LNCS 1233, pages 37-51, Springer, already refers to utilization of the information from the power consumption and from the electromagnetic radiation from the processor during computation or the implementation's behavior when errors are induced.

Mathematical methods for inversion are also found in Menezes, van Oorschot, Vanstone: Handbook of applied cryptography, CRC-Press 1996.

Masking techniques for crypto methods, particularly for DES and AES, are also known from Goubin, Patarin: DES and differential power analysis, CHES 1999, LNCS 1717, pages 158-172, Springer; Akkar, Giraud: An implementation of DES and AES, secure against some attacks, CHES 2001, LNCS 2162, pages 309-318, Springer; Messerges: Securing the AES finalists against power analysis attacks, FSE 2000, LNCS 1978, pages 150-164, Springer; Coron, Goubin: On boolean and arithmetic masking against differential power analysis, CHES 2000, LNCS 1965, pages 213-237, Springer; Trichina, de Seta, Germani: Simplified adaptive multiplicative masking for AES and its securized implementation, CHES 2002, LNCS 2523, pages 187-197, Springer; Golic, Tymen: Multiplicative masking and power analysis of AES, CHES 2002, LNCS 2523, pages 198-212, Springer.

The generation of digital signatures based on the digital signature standard is also a subject of discussion in FIPS 186: Digital signature standard, Federal Information Processing Standards Publication 186, NIST 1997.

### SUMMARY

A modular inversion in particular from SPA and DPA can be protected. Many cryptographic methods (particularly public key method) use arithmetic in finite bodies. An important computation step used in this context is the computation of modular inversions in finite bodies.

According to an embodiment, a method for side-channel-attack-resistant encryption and/or decryption of data using a computation unit, may comprise the steps of: determining, for example, in an encryption and/or decryption step, a return value as a modular inverse of an input value using a module, selecting, for example, in a first substep, a random number, producing, for example, in a second substep, a first product from the input value and the random number, determining, for example, in a third substep, by the module a modular inverse of the first product by implementing an algorithm for calculating the modular inverse without protection against a side channel attack, determining, for example, in a fourth substep, a second product from the random number and the modular inverse, and equating, for example, in a fifth substep, the return value to the second product.

According to a further embodiment, the random number, the first product, the second product and the modular inverse can be erased following determination of the return value. According to a further embodiment, the unprotected implementation can be based on the Euclidean algorithm.

According to another embodiment, a tachograph may comprise a computation unit, wherein the computation unit encrypts and/or decrypts data and is operable to perform an encryption and/or decryption step determining a return value as the modular inverse of an input value by using a module of the computation unit, wherein the computation unit is further operable to—use a first substep to select a random number,—use a second substep to produce a first product from the input value and the random number,—use a third substep to use the module to determine the modular inverse of the first product by implementing an algorithm for calculating the modular inverse without protection against a side channel attack,—use a fourth substep to determine a second product from the random number and the modular inverse, and to—use a fifth substep to equate the return value to the second product.

According to yet another embodiment, a mobile data storage medium, in particular a data card, may comprise a computation unit, wherein the computation unit encrypts and/or decrypts data and is operable to perform an encryption and/or decryption step to determine a return value as the modular inverse of an input value using a module of the computation unit, wherein the computation unit is further operable to—use a first substep to select a random number,—use a second substep to produce a first product from the input value and the random number,—use a third substep to use the module to determine the modular inverse of the first product by implementing an algorithm for calculating the modular inverse without protection against a side channel attack,—use a fourth substep to determine a second product from the random number and the modular inverse, and to—use a fifth substep to equate the return value to the second product.

### BRIEF DESCRIPTION OF THE DRAWINGS

The text below explains the invention in more detail using a specific exemplary embodiment with reference to drawings, the invention not being limited to the illustrations in this example. In the drawings:

FIG. 1 shows a schematic perspective illustration of an tachograph with a data card according to an embodiment,

FIG. 2 shows a schematic illustration of the operating sequence based on the method according to an embodiment.

### DETAILED DESCRIPTION

Methods for modular inversion usually either involve algorithms for calculating greatest common divisors (extended Euclidean algorithm or variants thereof, such as the binary-operation Stein's algorithm) or use Fermat's little theorem and hence attribute the inversion to modular exponentiation. Algorithms based on calculating a greatest common divisor have a highly data-dependent operating sequence: the number of division operations can be used to infer the number to be inverted, for example. In the case of the binary-operation Stein's algorithm, one is added to an interim value for the calculation of the body's module if this interim value is uneven. If an attacker can observe whether this addition is performed in the i-th step of the algorithm, he can discover the number to be inverted bit by bit. These algorithms therefore allow an attacker to easily infer the number which is to be inverted from runtime, power consumption or electromagnetic radiation. Although algorithms based on Fermat's little theorem have a constant operating sequence, they are much slower and therefore more inefficient.

Commonly used techniques for preventing side channel attacks either attempt to worsen the signal-to-noise ratio between the information to be protected and all other measurable signals and hence to make observing the secret information more difficult or use randomization techniques in order to remove the correlation between the information to be protected and the measured values. Methods for making observation of the secret information more difficult include, by way of example, the avoidance of data-dependent branches which are dependent on information worth protecting, the use of program steps with a current profile which has little fluctuation or the use of program parts whose runtime is no longer dependent on the computation data, execution of random and/or redundant program parts etc. These countermeasures generally protect against SPA attacks, but have the drawback that the implementation is subject to disadvantageous restrictions.

Randomization techniques for removing correlation between information which is to be protected and measured values are used to protect against the statistical analysis methods of DPA. Such measures usually involve masking the secret information with random values. For every new calculation, new independent random numbers are then chosen for the masks. An attacker then measures a calculation which he sees as random each time, because he does not know the mask and cannot establish any simple correlations between measured physical values and input or output data.

A method for calculating the modular inverse which is resistant to side channel attacks and at the same time keeps down restrictions for the implementation and the additional complexity for the purpose of protecting against side channel attacks can be provided according to various embodiments.

The technique according to various embodiments allows any implementations of methods for calculating modular inversions (including the very efficient algorithms based on calculation of a greatest common divisor) to be protected from SPA and DPA by a simple transformation.

The use of an arithmetic homomorphic masking technique according to various embodiments has, inter alia, the advantage that the masking can be performed at the beginning of the computation and the result could be demasked at the end and at the same time the implementation for the modular inversion is protected against SPA and DPA attacks.

According to an embodiment of an encryption or decryption method, particularly in an embodiment of a tachograph or a mobile data storage medium, is the necessary inversion when generating digital signatures on the basis of the digital signature standard DSA, for example:

Let p be a primary number, q|p−1 be a primary number, 0≦g≦p be a generator for the cyclic subgroup of the order q in (Z/pZ)*, 0<a<q be a secret key, A=ĝa mod p be the associated public key, and 0<=m<p be the message to be signed. To calculate the signature (r, s) for the message m and the public key A, the following computation steps are carried by the computation unit in line with the DSA:
1) selection of a random number 0≦k≦q, which needs to be kept secret
2) calculation of r=(âk mod p) mod q
3) calculation of the modular inversion h=1/k mod q using module M
4) calculation of s=h*(m+a*r) mod q

The calculation of the modular inversion in step 3) can particularly advantageously be protected against SPA, according to an embodiment, so that the secret random number k, what is known as the ephemeral key, does not become known to the attacker. If an attacker finds out the ephemeral key k, he could calculate the secret key a of the person creating this signature.

The module M, according to an embodiment, which has an implementation for calculating the modular inverses in a finite body K, can determine the modular inverse in side-channel-resistant fashion from an element a belonging to the finite body K, for example. In this context, the method, according to an embodiment, works using the following steps, for example:

1) the computation unit selects a random element c from K
2) the computation unit determines d=a*c
3) the module M determines the inverse e=M(d)
4) the computation unit determines b=e*c
5) the computation unit sets the return value r:=b

In step 3), an attacker observes just the inversion of a random body element d which is chosen with an even distribution and which is independent of the actual input a for the calculation. Since he does not know the randomly selected element c, neither SPA nor DPA attacks provide him with any information from the computation steps performed by M.

Another advantage of the method is that an unprotected implementation needs to be extended, according to an embodiment, only by steps 1), 2), 4) and 5) in order to obtain resistance against SPA and DPA. In particular, the efficient methods for calculating modular inverses can be used on the basis of the Euclidean algorithm without changes. In this case, the additional computation complexity is much lower than in the case of methods for inversion which involve Fermat's little theorem.

According to an embodiment, the method may provide for the interim results c, d and e to be erased after the respective computation steps.

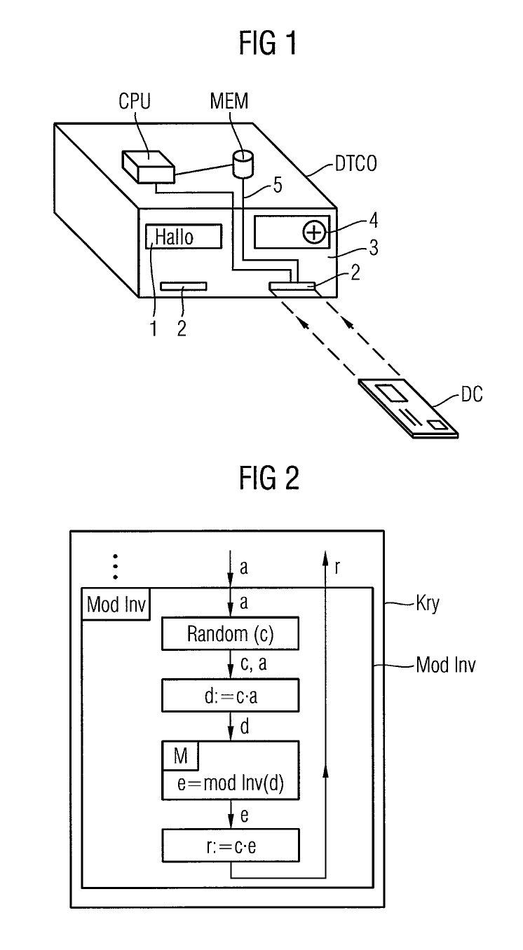

FIG. 1 shows an tachograph DTCO, according to an embodiment, and an data card DC, according to an embodiment. The data card DC can be inserted into the DTCO through one of two receiving slots 2, so that during a data transmission between the two elements the data card DC is held in the tachograph DTCO so that it is inaccessible from the outside. On its front 3, next to the two receiving slots 2, the tachograph DTCO has a display unit 1 and operator control elements 4. Following insertion into a receiving slot 2, the data card DC is connected to a central processor CPU by means of data lines 5, said central processor having access to an internal memory MEM. The data card likewise has an internal memory (not shown in detail) and a central processor.

The data transmission between the tachograph DTCO and the data card DC is performed with encryption by means of a session key, with the central processors CPU in the tachograph DTCO and in the data card DC determining a modular inverse of an input value A, inter alia, during the encryption and the decryption. To this end, the processors CPU make use of the module KRY shown in FIG. 2.

The module KRY is part of a sequence for the encryption. The input value a is transferred to the module KRY and is forwarded to the module Mod Inv inside this module. The module Mod Inv first of all determines a random number C and multiplies this number by the input value a to obtain a product d. The module M is used to determine the modular inverse e of the product d and then to multiply it by the random number c. A return value r is equated to this product and is returned to the module KRY as the result.

What is claimed is:

1. A method for side-channel-attack-resistant encryption and/or decryption of data using a computation unit, the method comprising the steps of:
determining in an encryption and/or decryption step a return value as a modular inverse of an input value using a module,
selecting in a first substep a random number,
producing in a second substep a first product from the input value and the random number,
determining in a third substep by the module a modular inverse of the first product by implementing an algorithm for calculating the modular inverse without protection against a side channel attack,
determining in a fourth substep a second product from the random number and the modular inverse, and
equating in a fifth substep the return value to the second product.

2. The method according to claim 1, wherein the random number, the first product, the second product and the modular inverse are erased following determination of the return value.

3. The method according to claim 1, wherein the unprotected implementation is based on the Euclidean algorithm.

4. A tachograph comprising a computation unit, wherein the computation unit encrypts and/or decrypts data and is operable to perform an encryption and/or decryption step determining a return value as the modular inverse of an input value by using a module of the computation unit, wherein the computation unit is further operable to
use a first substep to select a random number,
use a second substep to produce a first product from the input value and the random number,
use a third substep to use the module to determine the modular inverse of the first product by implementing an algorithm for calculating the modular inverse without protection against a side channel attack,
use a fourth substep to determine a second product from the random number and the modular inverse,
use a fifth substep to equate the return value to the second product.

5. A mobile data storage medium comprising a computation unit, wherein the computation unit encrypts and/or decrypts data and is operable to perform an encryption and/or decryption step to determine a return value as the modular inverse of an input value using a module of the computation unit, wherein the computation unit is further operable to
use a first substep to select a random number,
use a second substep to produce a first product from the input value and the random number,
use a third substep to use the module to determine the modular inverse of the first product by implementing an algorithm for calculating the modular inverse without protection against a side channel attack,
use a fourth substep to determine a second product from the random number and the modular inverse,
use a fifth substep to equate the return value to the second product.

6. The mobile storage medium according to claim 5, wherein the mobile storage medium is a data card.

7. A method for side-channel-attack-resistant encryption and/or decryption of data using a computation unit, the method comprising the steps of:
selecting a random number,
producing a first product from the input value and the random number,
determining by the module a modular inverse of the first product by implementing an algorithm for calculating the modular inverse of the first product without protection against a side channel attack,
determining a second product from the random number and the modular inverse of the first product, and
equating and outputting a return value to the second product.

8. The method according to claim 7, wherein the random number, the first product, the second product and the modular inverse of the first product are erased following determination of the return value.

9. The method according to claim 7, wherein the algorithm is based on the Euclidean algorithm.
